(19) United States
(12) Patent Application Publication
(10) Pub. No.: US 2024/0386094 A1
(43) Pub. Date: Nov. 21, 2024

(54) APPARATUS AND METHOD FOR POINTER AUTHENTICATION

(71) Applicant: Arm Limited, Cambridge (GB)

(72) Inventors: Alexander Alfred Hornung, Cambridge (GB); Ian Michael Caulfield, Cambridge (GB)

(73) Assignee: Arm Limited, Cambridge (GB)

(21) Appl. No.: 18/577,970

(22) PCT Filed: Jul. 7, 2022
(86) PCT No.: PCT/GB2022/051754

§ 371 Date: Jan. 9, 2024

(30) Foreign Application Priority Data
Jul. 15, 2021 (GB) 2110180.3

(51) Int. Cl. G06F 21/54; G06F 9/38; G06F 21/44

(52) U.S. Cl. CPC G06F 21/54; G06F 9/3836; G06F 21/44; G06F 2221/033

(57) ABSTRACT

An apparatus has processing circuitry to execute instructions and address prediction storage circuitry to store address prediction information for use in predicting upcoming instructions to be executed by the processing circuitry. The processing circuitry is responsive to an instruction to generate a pointer signature for a pointer to generate the pointer signature for the pointer based on an address of the pointer and a cryptographic key. The address prediction storage circuitry is also configured to store address prediction information for the pointer, the address prediction information including the pointer. The processing circuitry is responsive to an instruction to authenticate a given pointer to obtain, based on the address prediction information for the given pointer, a predicted pointer signature; compare the predicted pointer signature with a pointer signature identified by the instruction to authenticate; and responsive to the comparing detecting a match, determine that the given pointer is valid.

The present disclosure relates to the field of data processing. More particularly, the present disclosure relates to pointer authentication.

Data processing apparatuses employ pointer authentication to protect against accidental or malicious modification of pointers. Such modification could be used to alter program flow and thereby allow unintended and potentially malicious code to be executed or allow normally safe code to be executed in a malicious way. Pointer authentication may involve generating a pointer signature or pointer authentication code for a pointer. This pointer signature may be generated based on a cryptographic key and using a cryptographic operation so that without knowledge of the cryptographic key, a valid pointer signature cannot easily be generated. The pointer may later be authenticated or verified to identify whether the pointer has been tampered with since the pointer signature was generated. If the pointer has been modified, the apparatus may detect that the pointer signature is not a proper pointer signature for the pointer and determine that the pointer is invalid.

In one example arrangement, there is provided an apparatus comprising: processing circuitry to execute instructions; address prediction storage circuitry to store address prediction information for use in predicting upcoming instructions to be executed by the processing circuitry; wherein the processing circuitry is responsive to an instruction to generate a pointer signature for a pointer to generate the pointer signature for the pointer based at least in part on an address of the pointer and a cryptographic key; the address prediction storage circuitry is configured to store address prediction information for the pointer, the address prediction information comprising at least the pointer; and the processing circuitry is responsive to an instruction to authenticate a given pointer to: obtain, based on the address prediction information for the given pointer, a predicted pointer signature; compare the predicted pointer signature with a pointer signature identified by the instruction to authenticate; and responsive to the comparing detecting a match, determine that the given pointer is valid.

In another example arrangement, there is provided a method of authenticating a pointer, the method comprising: generating, in response to an instruction to generate a pointer signature for a pointer, the pointer signature for the pointer based at least in part on an address of the pointer and a cryptographic key; storing, in address prediction storage circuitry, address prediction information for the pointer, the address prediction information comprising at least the pointer, the address prediction information for use in predicting upcoming instructions be executed by processing circuitry; and in response to receiving an instruction to authenticate a given pointer: obtaining, based on the address prediction information for the given pointer, a predicted pointer signature; comparing the predicted pointer signature with a pointer signature identified by the instruction to authenticate; and responsive to the comparing detecting a match, determining that the given pointer is valid.

The present invention will be described further, by way of example only, with reference to embodiments thereof as illustrated in the accompanying drawings, in which:

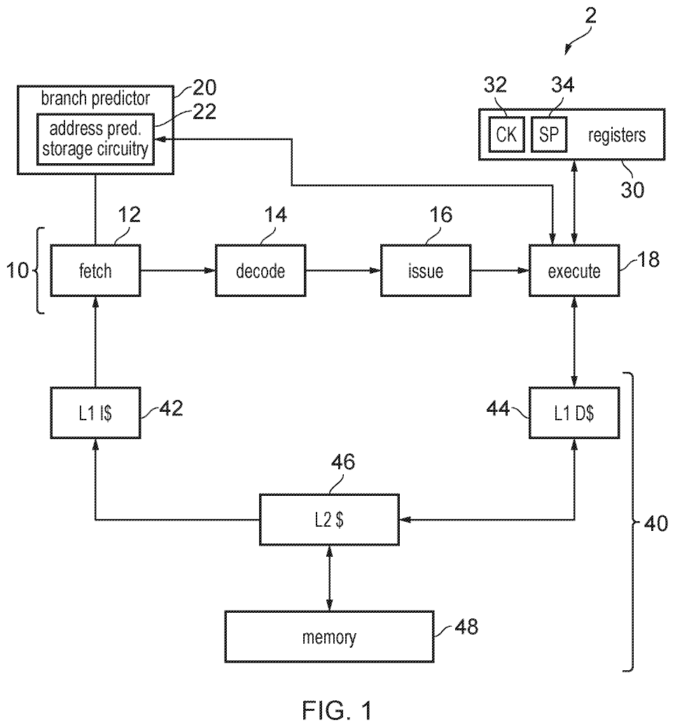

FIG. 1 is a block diagram of an apparatus in which the techniques described herein may be employed;

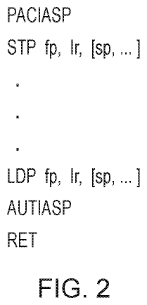

FIG. 2 is an example of program code associated with entering and returning from a function;

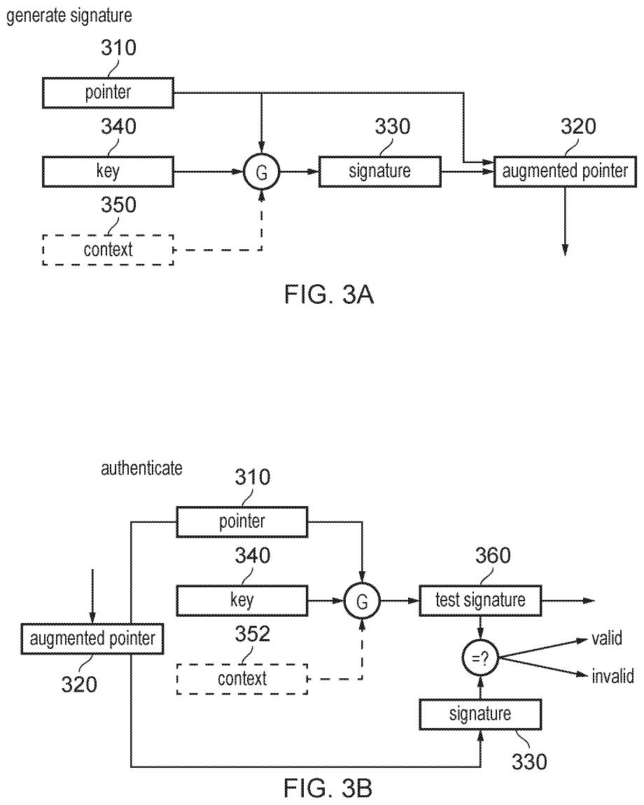

FIGS. 3A and 3B schematically illustrate an approach to generating and authenticating a pointer respectively;

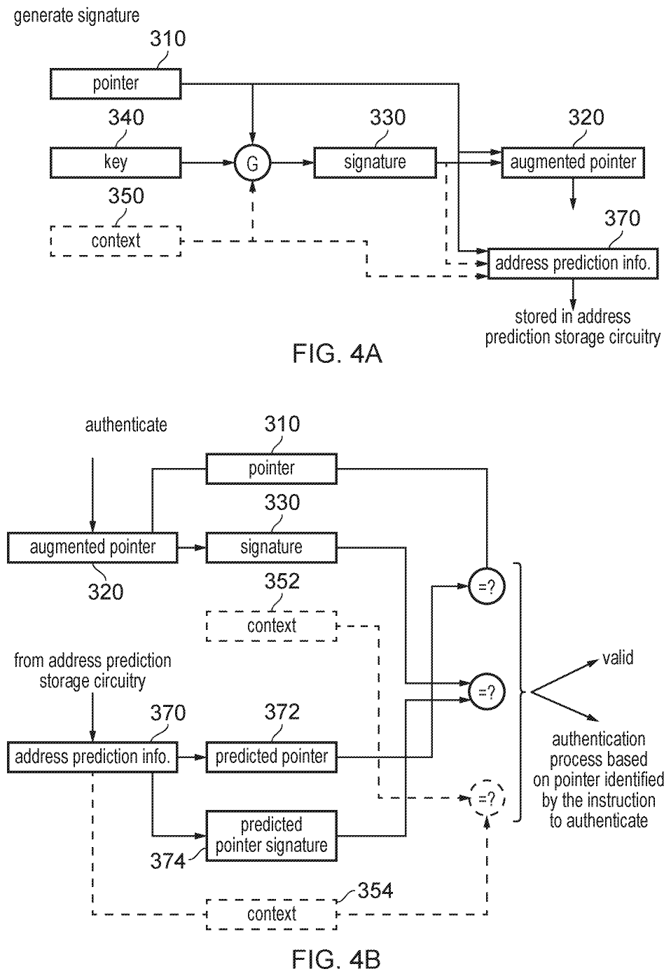

FIG. 4A schematically illustrates an approach to generating a pointer signature in which address prediction information is stored to address prediction storage circuitry;

FIG. 4B schematically illustrates a first approach to authenticating a pointer making use of a predicted pointer signature obtained from address prediction information;

FIG. 4C schematically illustrates a second approach to authenticating a pointer making use of a predicted pointer signature obtained from address prediction information;

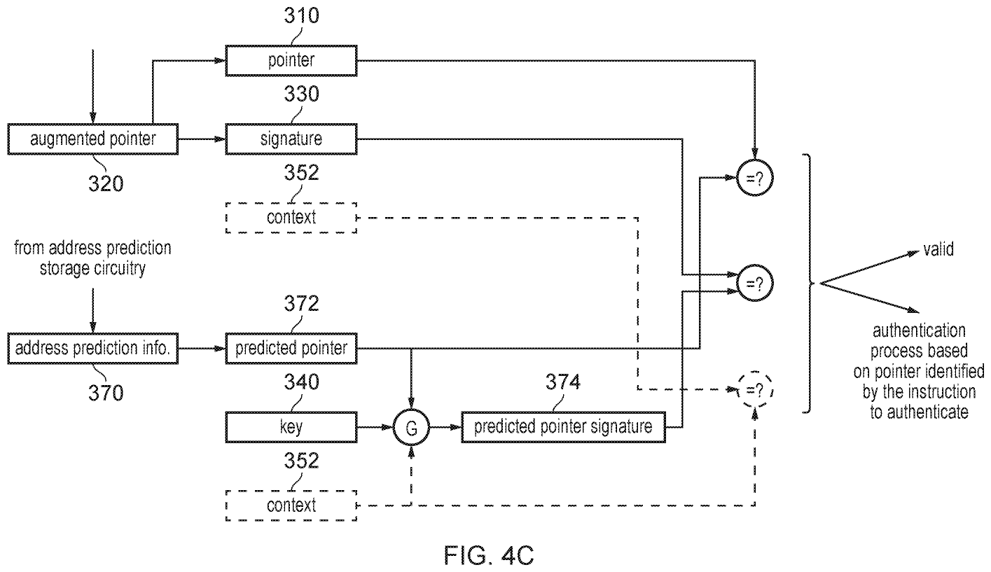

FIGS. 5A-5C are a timing diagrams illustrating efficiency improvements that could be achieved with the present techniques;

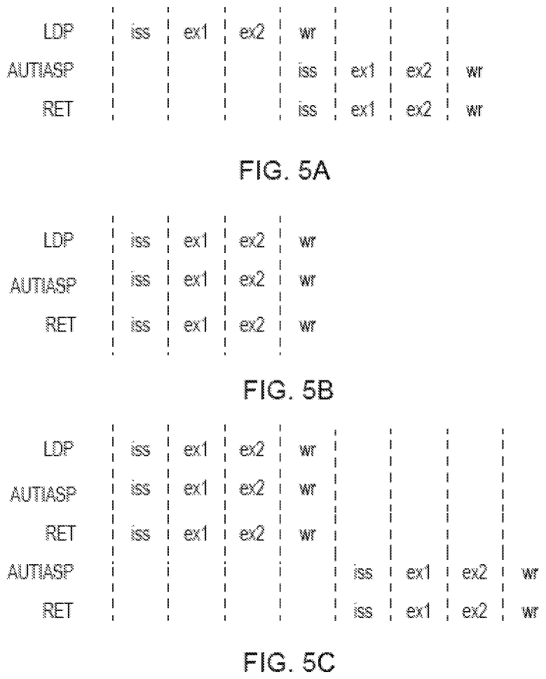

FIG. 6 illustrates an augmented pointer in which a subset of bits of a pointer are replaced with a pointer signature;

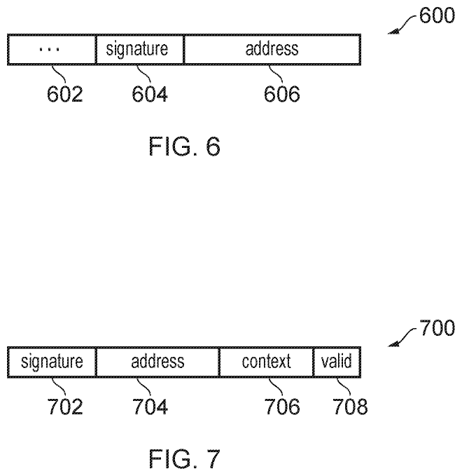

FIG. 7 illustrates example address prediction information for a pointer;

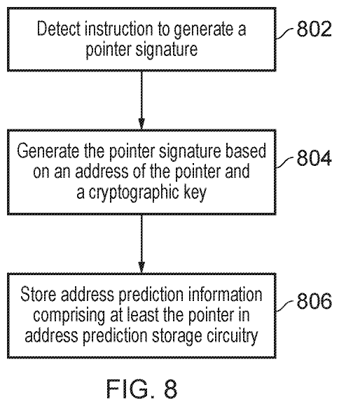

FIG. 8 is a flow diagram illustrating a method of generating a pointer signature; and

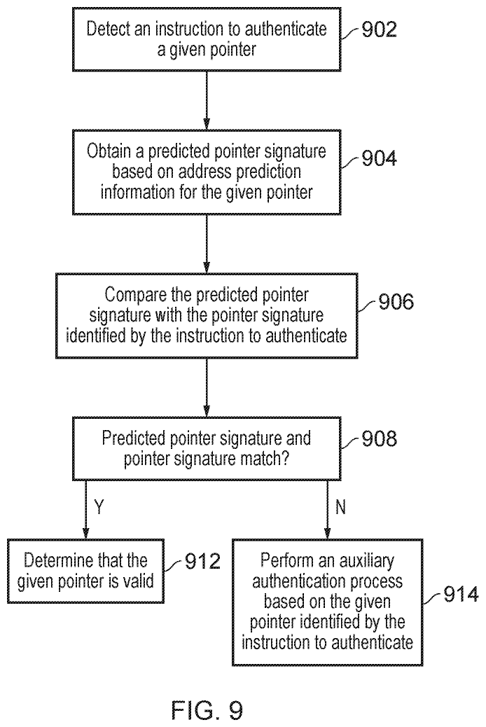

FIG. 9 is a flow diagram illustrating a method of authenticating a pointer.

Before discussing the embodiments with reference to the accompanying figures, the following description of embodiments is provided.

As mentioned earlier, pointer authentication may be used to detect when a pointer has been modified. Processing circuitry may be arranged to generate a pointer signature (or pointer authentication code) based on an address of the pointer. The pointer signature may be generated by way of a cryptographic operation performed on an address of the pointer and a cryptographic key stored in the apparatus.

A pointer signature may, for example, be generated when a pointer is to be stored in a memory system. For example, on function call, the processing circuitry may be arranged to store, in the memory system, a pointer indicating a return address to which program flow should branch on function return. To protect against accidental or malicious modification of the pointer stored in the memory system, the processing circuitry may generate the pointer signature or pointer authentication code for the pointer before the pointer is stored to the memory system. The pointer signature can later be authenticated (or verified) to determine whether the pointer has been tampered with before a memory location associated with the pointer is referenced (e.g., before returning from the function).

In authenticating the pointer signature, the processing circuitry determines whether the pointer signature corresponds to the memory address of the pointer retrieved from the memory system. This could, for example, be done by generating a test signature using the same cryptographic operation and based on the pointer retrieved from the memory system and the cryptographic key to generate a test signature. If this test signature matches the signature retrieved from the memory system, then the processing circuitry may determine that the pointer signature is valid and so the pointer can be used. On the other hand, if the signatures do not match, the processing circuitry may determine that the signature is invalid. On this basis, the processing circuitry may prevent the pointer being used and/or raise an exception.

This technique may be therefore used to detect modification of the pointer. That is, if the address of the pointer is modified after the signature has been generated, the authentication process will generate a different test signature to the pointer signature and the processing circuitry will detect that the pointer signature is invalid for that pointer. Thus, if the address of a pointer in the memory system is modified maliciously or accidentally without knowledge of the cryptographic key and the cryptographic operation used to generate the signature, a valid signature for the modified pointer may not be generated, and so the pointer signature will not be valid.

This approach therefore provides increased security to prevent against modification of pointers. Since such pointers may be referenced when controlling program flow (e.g., where the pointer indicates a return address), it is particularly important to be able to detect such modification. Otherwise, modification of pointers by attackers may allow the processing circuitry to branch to unintended portions of code allowing attackers to run malicious code on the processing circuitry.

However, authentication of a pointer signature carried out on the basis of a given pointer identified by an instruction to authenticate that given pointer can lead to delays in the use of the given pointer. For example, the authentication process may need to wait for the pointer and pointer signature to be fetched from the memory system, and so the authentication process (which may take several processor cycles to complete) cannot be carried out until the pointer has been retrieved. Therefore, whilst pointer authentication may improve security, it may also add several cycles to the process of referencing a pointer due to the need to wait for the pointer to be fetched before the authentication process can be commenced.

However, the inventors recognised that often in such apparatuses, an address prediction mechanism (e.g., a branch prediction mechanism) will predict the address to which program flow will branch with a high degree of accuracy even before the pointer indicating the location has been retrieved. Accurate address prediction may be particularly relevant in the case of function return where address prediction circuitry maintains an address prediction structure in the form of a call-return stack. On function call, the return address is pushed to the call-return stack and so by popping an address from the call-return stack on function return, the return address can be predicted with a high level of accuracy even before the return address has been fully resolved (e.g., by identification of the return address in the link register or by fetching the return address from the memory system).

Thus, in accordance with the techniques described herein, the processing circuitry carries out the authentication process using the address prediction information stored in address prediction storage circuitry. In this way, the authentication process can be commenced even before the pointer has been identified, avoiding/reducing a delay due to the need to authenticate a pointer. This approach therefore improves the efficiency of the authentication process whilst maintaining security.

In accordance with the techniques described herein, processing circuitry of an apparatus is responsive to an instruction to generate a pointer signature for a pointer. The processing circuitry is configured to, in response to this instruction, generate the pointer signature for the pointer based at least in part on an address of the given pointer and a cryptographic key. The form of the instruction to generate a pointer signature may depend on the instruction set architecture (ISA) used by the processing circuitry. For example, the ISA may include an instruction specifically indicating that a pointer signature is to be generated or the instruction may indirectly indicate that a pointer signature is to be generated (e.g., a pointer signature may be generated in response to an instruction to store a memory address to the memory system). Various operations may be used to generate the pointer signature, but in some examples, a hash function is applied to a combination of the address of the given pointer and the cryptographic key or a block cipher may be applied to the address using the cryptographic key. In either of these examples, a salt may also be introduced to improve security. That is, a salt (which may comprise context information such as the stack pointer) may be combined with the address of the given pointer before the address is subject to the cryptographic operation, thereby further obscuring the association between the address used and the resulting cryptographic key. The cryptographic key may be stored in a special purpose register accessible only in response to instructions to generate/authenticate pointers. In some examples, the apparatus stores a plurality of cryptographic keys for use in pointer authentication with the instruction to generate a pointer indicative of which key should be used. This approach allows different keys to be reserved for different contexts in which pointer authentication may be applied.

Elements described herein may be implemented in dedicated circuitry, or as logical elements of general-purpose circuitry. The processing circuitry may for example comprise a central processing unit (CPU), graphics processing unit (GPU), or parts thereof.

The apparatus may also comprise address prediction storage circuitry to store address prediction information for use in predicting upcoming instructions to be executed by the processing circuitry. For example, the address prediction storage circuitry may be implemented within branch prediction circuitry used to predict the presence of branches, target of branches and/or whether the branches will be taken or not taken. For example, the address prediction storage circuitry may be a branch target buffer configured to store information about targets of branch instructions. Additionally or alternatively, the address prediction storage circuitry may implement a call-return stack used to predict the return address when returning from a function.

In accordance with the techniques described herein, the address prediction storage circuitry is configured to store address prediction information for the pointer for which the pointer signature was generated. This address prediction information comprises at least the given pointer but may also comprise further information such as the pointer signature and/or context information indicative of the state of the processing circuitry at the time the pointer signature was generated, as will be discussed in more detail below. This address prediction information may be used for predicting upcoming instructions to be executed by the processing circuitry (e.g., in branch prediction).

The apparatus may perform address prediction to predict upcoming instructions that are to be executed by the processing circuitry. These predictions can be used to speculatively fetch the instructions to be executed, thereby reducing delays in execution by the processing circuitry when branches occur. As such, when a branch occurs (such as on function return), the memory address to which program flow will branch is often predicted with a high degree of accuracy even before the address is fully resolved.

However, in accordance with the techniques described herein, the address prediction information stored in the address prediction storage circuitry is also used when authenticating pointers and their signatures. In response to an instruction to authenticate a pointer, the processing circuitry is configured to obtain a predicted pointer signature based on the address prediction information. Since the address prediction information is often available early (before the pointer itself has been retrieved), the processing circuitry may not have to wait for the pointer to be retrieved before starting to obtain the predicted pointer signature. As such, delays in the pointer authentication process can be elided by making use of the predicted pointer signature from the address prediction information. When both the pointer signature identified by the instruction to authenticate and the predicted pointer signature based on the address prediction information are available, the processing circuitry compares the pointer signature with the predicted pointer signature. Based on the results of the comparison, the processing circuitry determines whether the given pointer is valid. If the predicted pointer signature and the pointer signature identified by the instruction to authenticate match, then the processing circuitry may determine that the pointer is valid. If the predicted pointer signature and the pointer signature identified by the instruction to authenticate differ, then the processing circuitry may perform an auxiliary authentication process to confirm the authenticity of the pointer, raise an exception and/or prevent the pointer being used.

In some examples, the processing circuitry is also configured to perform a comparison between the pointer as predicted in the address prediction information and the pointer as identified by the instruction to authenticate. This comparison may be used to determine whether the pointer was correctly predicted. In some examples, it may be possible for the address prediction mechanism to incorrectly predict the address, in which case the pointer from the address prediction information would not match the pointer identified by the instruction to authenticate. In this case, where the comparison determines that the address of the pointer was incorrectly predicted, the results of the comparison between the predicted pointer signature (as obtained from the address prediction information) and the pointer signature identified by the instruction to authenticate may be disregarded, and the authentication process repeated on the basis of the pointer identified by the instruction to authenticate.

The instruction to authenticate the given pointer may for example be a specific instruction or one of a number of specific instructions provided for in an ISA. In such a case, the instruction may indicate that authentication is to be carried out and may identify a particular pointer for which authentication is to be performed. In some examples, the instruction identifies a register in which the pointer is stored, however, the instruction may alternatively indicate a location in memory at which the pointer to be authenticated is stored. In some examples however, the instruction to authenticate is not a dedicated authentication instruction and the processing circuitry is instead configured to be responsive to any suitable form of instruction to indirectly indicate that authentication may be carried out. For example, the processing circuitry may be configured to carry out authentication in response to a branch instruction that indicates that program flow should branch to a memory location indicated by a particular pointer. In this way, the branch instruction may implicitly indicate that the particular pointer is to be authenticated.

In some examples, the execution of the instruction to authenticate the pointer triggers the processing circuitry to carry out the authentication process. However, in some examples, the processing circuitry is provided with dedicated circuitry configured to identify such an instruction earlier in a pipeline of the processing circuitry and begin obtaining the address prediction information in advance of execution of the instruction to authenticate. In this way, the processing circuitry is able to further reduce the impact of the pointer authentication process on the speed at which pointers can be referenced whilst maintaining the security afforded by authenticating pointers. In one example, the processing circuitry is configured to identify, at the decode stage of a pipeline implemented by the processing circuitry, an instruction or sequence of instructions indicative of the request to authenticate a pointer. In response to this identification, the processing circuitry modifies the instruction(s) to cause the processing circuitry to carry out the authentication. This may occur for example by supplementing the identified instruction(s) with the return address predicted by the address prediction circuitry to produce an instruction that causes the processing circuitry to generate an authentication code based on that return address, or by modifying the instruction to trigger a comparison of the pointer signature stored in the address prediction storage circuitry with the pointer signature identified by the instruction to authenticate.

As described above, the processing circuitry makes use of the predicted pointer signature obtained from the address prediction information and compares this with the pointer signature identified by the instruction to authenticate. By obtaining the predicted pointer signature from the address prediction information, at least some of the cost of generating a signature based on the pointer identified by the instruction to authenticate can be elided. Obtaining this predicted pointer signature from the address prediction information may be implemented in a number of ways.

In some examples, the address prediction storage circuitry is configured to additionally store the pointer signature for a pointer. As such, when the address prediction information is used to authenticate a pointer, the address prediction information for the given pointer comprises both the given pointer itself and the predicted pointer signature for the given pointer. Obtaining the predicted pointer signature therefore involves identifying the predicted pointer signature stored in the address prediction storage circuitry which can then be compared with the pointer signature of the pointer identified by the instruction to authenticate. By additionally storing the pointer signature in the address prediction information, the processing circuitry is not only able to obtain a predicted pointer signature against which the pointer signature to verify can be compared without having to wait for the pointer identified by the instruction to authenticate to be identified and retrieved, but this approach also avoids having to perform a cryptographic operation to generate a pointer signature for the authentication. Since the predicted pointer signature can be directly retrieved from the address prediction storage circuitry, the potentially considerable cost of performing a cryptographic operation to generate a signature for comparison in the authentication process is elided. As such, the pointer authentication process may be carried out more quickly, reducing the impact of pointer authentication on the efficiency of the processing circuitry whilst maintaining the additional security benefits afforded by pointer authentication.

Another approach to obtaining the predicted pointer signature from the address prediction circuitry involves generating the predicted pointer signature based at least in part on an address of the given pointer from the address prediction information and the cryptographic key. By calculating the predicted pointer signature from the pointer stored in the address prediction information in this way, the address prediction storage circuitry does not need to store the pointer signature itself in the address prediction information. This can reduce the space taken up in the address prediction storage circuitry by the address prediction information. This approach may also be more suitable where it is difficult or impossible to extend the address prediction storage circuitry to store pointer signatures due to modification that may be required to such circuitry from existing address prediction storage circuitry. Although generating the predicted pointer signature from the address prediction information still makes use of the cryptographic operation, this approach may still allow the authentication process to be performed more efficiently than where a signature for comparison is generated based on the pointer identified by the instruction to authenticate. Specifically, by virtue of its role in predicting upcoming addresses, the address prediction information may be available earlier than the target of the instruction to authenticate can be identified. As such, the processing circuitry can begin to generate the predicted pointer signature for comparison with the pointer signature identified by the instruction to authenticate before the pointer identified by the instruction to authenticate has been determined.

In some examples, the processing circuitry is configured to generate a pointer signature based only on the address of the pointer in question and the cryptographic key. However, where this is the case, the same pointer signature may be valid for a particular address of pointer regardless of where in program flow the pointer is encountered. As such, the apparatus may be more vulnerable to replay attacks than an apparatus which is able to additionally take into account the execution state of the processing circuitry when generating and authenticating pointers. Although it may be difficult for an attacker to generate a valid pointer signature for an arbitrary pointer, if the attacker is able to determine a validly created pointer signature for a particular memory location, the attacker may be able to re-use said pointer and pointer signature combination in a different context to divert program flow to the memory location referenced by the pointer despite execution of instructions from this location not being intended.

In order to mitigate against such replay attacks, the processing circuitry may be configured to generate the pointer signature based further on context information associated with a current execution state of the processing circuitry. For example, the processing circuitry may be configured to generate the pointer signature based on the position of the stack pointer when the pointer signature is generated. As used herein, the stack pointer refers to a location in a memory system corresponding to the top of a program stack referenced by the processing circuitry. By taking into account the context information (e.g., stack pointer) when generating the pointer signature, if that pointer signature were to be reused elsewhere where the context information differs, the authentication process would determine that the pointer signature is invalid, even if the pointer signature were being reused for a pointer with the same address as the pointer for which the pointer signature was originally generated.

Where the processing circuitry makes use of context information (e.g., the stack pointer) to generate the pointer signature, the processing circuitry may be configured to store this context information as part of the address prediction information. For example, the context information may be stored as part of the address prediction information along with the pointer itself when the pointer signature is generated or in response to another trigger (e.g., on function call). In this way, the context information associated with the execution state of the processing circuitry at the time the pointer signature was generated may be available to the processing circuitry for use when authenticating a pointer. The processing circuitry may therefore be configured to take this context information into account when authenticating a pointer. This could be done by obtaining the context information from the address prediction information, comparing the context information with current context information indicative of a processing state of the processing circuitry at the time the authentication is being carried out, and determining that the given pointer is valid if both the predicted pointer signature and the context information from the address prediction information match the corresponding pointer signature and context information to which they are compared. This approach allows the context information to be checked in the authentication process without requiring the cryptographic operation to be performed to produce a new pointer signature. Consequently, the processing circuitry is able to provide the increased security against replay attacks afforded by taking into account context information whilst still performing the authentication process in an efficient manner.

Another way in which the context information may be taken into account during the authentication process is by generating the predicted pointer signature from the address prediction information based at least in part on the address of the given pointer from the address prediction information, the cryptographic key, and context information associated with a state of the processing circuitry. In some examples, the processing circuitry is configured to store context information as part of the address prediction information and the context information used to generate the predicted pointer signature is context information from the address prediction information. However, in some examples in which context information may not be stored in the address prediction storage circuitry, the processing circuitry is configured to generate the predicted pointer signature based on current context information indicative of an execution state of the processing circuitry at the time the authentication is carried out.

Although the techniques described herein may be applied generally where it is desired to generate and authenticate a pointer signature, these techniques may be particularly beneficial when applied to function call and return. On function call, program flow typically branches to the location of the function being called and a return pointer indicative of a return address is stored in a link register. The contents of the link register can then be written to the memory system of the apparatus. On function return, following execution of the function, the return address is retrieved from the memory system (or directly from the link register) and program flow returns to the memory location indicated by the return pointer. Consequently, malicious or inadvertent modification of the return pointer stored in the memory system poses a risk of diverting program flow to unintended locations. For example, an attacker could modify the return address stored in the memory system such that on function return, the processing circuitry diverts program flow to a location specified by the attacker, thereby allowing the attacker to execute malicious code stored at that location. As such, function call and return represents an important situation in which pointer authentication may be employed.

Therefore, in some examples the processing circuitry is configured to generate the pointer signature in connection with a function call operation. This processing circuitry may be configured to generate this pointer signature directly in response to the function call operation with the function call acting as the instruction to generate a pointer signature. Alternatively, or additionally, the processing circuitry may be responsive to a specific signature generation instruction to generate the pointer signature, with that signature generation instruction being found in program code at the start of a function. In such situations, the given pointer may be a return pointer to identify the next instruction to be executed following a function return operation. Typically, this pointer will indicate the instruction following the branch instruction that caused entry into the function. The processing circuitry may be configured to authenticate this return pointer in preparation for the function return operation. Similarly to the function call operation, the processing circuitry may be responsive to the return instruction itself to authenticate the return pointer, or the program code may contain a specific signature authentication instruction that triggers the processing circuitry to carry out the authentication. In order to reduce the impact of the pointer authentication process on the time taken to carry out function return, the processing circuitry may begin the authentication process before the instruction to authenticate is executed, instead being responsive to the instruction to authenticate being detected earlier in a pipeline of the processing circuitry to begin obtaining the predicted pointer signature from the address prediction information.

Often, particularly accurate address prediction may be provided for function call and return. Since the hierarchy of potentially nested function calls can be well represented using a stack structure, the apparatus may be provided with call-return stack storage circuitry which maintains a call-return stack. Return addresses are pushed to the call-return stack on function call meaning that the return address for a function return operation can be accurately and quickly predicted by popping the most recent entry from the call-return stack. Therefore, in some examples, the address prediction storage circuitry is the call-return stack storage circuitry to store call-return prediction information for use in predicting a return memory address of an instruction to be executed following a function return operation. By making use of the address prediction information stored in the call-return stack storage circuitry, the apparatus is able to take advantage of the quick and accurate prediction of addresses to enable the authentication of return addresses encountered to be authenticated efficiently.

Where the apparatus needs to store a pointer and a corresponding pointer signature in association with each other, this may be done by storing the pointer and pointer signature separately but in related locations, e.g., in subsequent memory locations in the memory system. However, in some instruction set architectures (ISAs), more bits are allocated for pointers than are occupied by the unique bits of the memory address of each pointer. In such examples, a set of bits (e.g., the most significant bits) of pointers may always have the same value (e.g., zero). In such cases, the processing circuitry may be configured to replace at least some of these bits with the pointer signature to create an augmented pointer. By storing this augmented pointer instead of storing the pointer and pointer signature separately, the apparatus may reduce the space occupied where the pointer and pointer signature are stored together (e.g., in the memory system or in the address prediction storage circuitry).

In some examples, in response to detecting a mismatch in the comparison of the predicted pointer signature obtained from the address prediction information and the pointer signature identified by the instruction to authenticate (and the comparison of the context information where such a comparison is carried out), the processing circuitry is configured to determine that the given pointer is invalid.

However, in some examples, and based on a recognition that a mismatch could be detected in the comparison despite the pointer signature identified by the instruction to authenticate being valid for its associated pointer (e.g., if address prediction circuitry predicts the wrong address), the processing circuitry is configured to perform an auxiliary authentication process in response to detecting a mismatch in the comparing. By performing this auxiliary authentication process, the authentication of the pointer may be delayed in the situations where the auxiliary authentication process is required. However, where the prediction is frequently correct and there are relatively few cases of invalid pointers, the savings achieved by making use of the address prediction information in the first instance may outweigh the costs of having to perform the auxiliary authentication process when a mismatch is detected in the comparison.

The auxiliary authentication process may be based on generating a test pointer signature from the pointer identified by the instruction to authenticate. This test pointer signature may then be compared against the pointer signature. If the processing circuitry detects a match between the test pointer signature and the pointer signature identified by the instruction to authenticate, the processing circuitry may determine that the given pointer is valid despite a mismatch initially being detected in the authentication process based on the address prediction information.

On the other hand, if a mismatch is detected in the auxiliary authentication process, the processing circuitry may be configured to determine at this stage that the given pointer is invalid.

A number of possible responses to determining that a pointer is invalid could be implemented. Since the pointer being invalid may indicate that the pointer is unsafe to use, in one example the processing circuitry may prevent the pointer being referenced and/or raise an exception.

Particular examples will now be described with reference to the figures.

FIG. 1 is a block diagram of an apparatus 2 in which the techniques described herein may be employed. It will be appreciated that this is a high level representation of a subset of components of the apparatus 2 and the apparatus 2 may include many other components not illustrated. The apparatus 2 comprises processing circuitry 10 to execute instructions. The processing circuitry 10 is coupled to main memory 48 via a cache hierarchy comprising multiple levels of cache 42, 44, 46. In this example, a level 1 instruction cache 42, a level 1 data cache 44, a level 2 cache 46 shared between data and instructions, and main memory 48 make up the memory system 40 of the apparatus 2. However, it will be appreciated that other cache hierarchies are possible and this is just one example.

The processing circuitry 10 has a fetch stage 12 that seeks to fetch from memory instructions that will be required to be executed by the processing circuitry 10. The fetch stage 12 has access to branch prediction circuitry 20 (or generally address prediction circuitry) to predict the instruction flow through a computer program, and hence predict which instructions should be fetched next. The branch prediction circuitry 20 makes use of address prediction storage implemented by address prediction storage circuitry 22 to store data used in predicting the addresses of upcoming instructions to be executed. In this example, the address prediction storage circuitry 22 is call-return stack storage circuitry to store call-return stack prediction information for use in predicting the location to which program flow will return following a function return operation. However, it will be recognised that the techniques described herein may be used with any suitable form of address prediction and the address prediction storage circuitry 22 could instead be a branch target buffer (BTB) storing information about the target addresses of branches encountered by the processing circuitry 10 for use in predicting the target of future branch instructions. In this example, call-return stack storage circuitry is used due to the high prediction accuracy.

Instructions that are fetched by the fetch stage 12 are then passed to a decode stage 14 where they are decoded in order to produce decoded instructions (sometimes also referred to as micro or macro operations) which are then stored within the issue stage 16. Once the source operands are available for those decoded instructions, those decoded instructions can be passed to the execute stage 18 for execution. When executing instructions, the source operand values required may be retrieved from registers 30 and the results produced by the execution of those instructions can be stored back into specified registers of the registers 30.

Load and store instructions can be executed to store data values from the registers 30 into the memory system 40 or to retrieve data from the memory system 40 to be stored in the registers 30. As shown in FIG. 1, when executing load or store instructions, the execution stage will interface with the L1 data cache 44 and from there to one or more lower levels of cache 46/main memory 48.

The processing circuitry 10 may store memory addresses in the form of pointers in the registers 30 and/or the memory system 40. It can be important to ensure that these pointers are not tampered or otherwise altered between being stored in the registers 30 and/or memory system 40 and later being referenced. This is because alteration of the pointers may affect the operation of the processing circuitry 10 where the operation of the processing circuitry 10 is dependent on the address of the pointer. For example, where the pointer is used to indicate the location of data to be used in a calculation, modification of the pointer could lead to the wrong data being used in the calculation, thereby leading to unexpected behaviour. Ensuring the integrity of pointers is particularly important where the pointer is used to indicate a memory location containing instructions to be executed by the processing circuitry 10. In this case, modification of the pointer could lead to the wrong code being executed by the processing circuitry 10. If occurring inadvertently, this could lead to unexpected or undefined behaviour. Deliberate modification of pointers however could also be used by attackers to divert program flow to memory locations storing malicious code, thereby allowing the attacker to run malicious code on the processing circuitry 10.

In order to detect modification of pointers and thereby improve security, the apparatus 2 implements pointer authentication. Pointer authentication involves generating a pointer signature in a manner that is difficult or impossible to do without proper authorisation. The pointer can later be authenticated to determine whether the pointer and pointer signature correspond to one another. If the pointer and pointer signature do not correspond this may indicate that the pointer or pointer signature has been tampered with or that the pointer is being used in an unintended manner.

Pointer authentication as described herein makes use of a cryptographic key to generate and authenticate pointers. As shown in FIG. 1, the registers 30 include a single cryptographic key register 32, however, it will be appreciated that the registers 30 may comprise multiple cryptographic key registers for storing cryptographic keys for use in different scenarios.

In some examples, pointer authentication also makes use of context information to verify that the context in which the pointer signature was generated corresponds to the context in which the pointer is authenticated. This can help mitigate against replay attacks whereby a valid pointer signature from one context is copied and used in a context in which is not intended. In the example shown in FIG. 1, the registers 30 comprise a stack pointer register 34 to store a current position of the stack pointer. The stack pointer is used to indicate a location in the memory system 40 associated with the end of the program stack (which may also be referred to as the top of the program stack) at which data associated with the most-recent call (e.g., most-recent function call) is stored.

How the pointer signature is generated and authenticated will be discussed in more detail with reference to FIGS. 3A-3B and 4A-4C.

In order to reduce the impact of performing pointer authentication, the processing circuitry 10 makes use of the address prediction carried out by the branch predictor 20 on the basis of the address prediction information in the address prediction storage circuitry 22. If the processing circuitry 10 did not make use of this address prediction information, the processing circuitry 10 may otherwise have to wait until an instruction indicating that pointer authentication is to be carried out reaches the execute stage 18. Since the pointer authentication process itself may be relatively costly in terms of the number of clock cycles required to be performed and power consumed, by avoiding or reducing the impact of this pointer authentication, the operation of the processing circuitry 10 may be made more efficient.

However, since the address prediction circuitry (e.g., branch predictor 20) is often able to predict with a high level of accuracy the address to which a branch/return instruction will divert program flow, the processing circuitry 10 is arranged to start to carry out the authentication process on the basis of the predicted pointer. Consequently, the processing circuitry 10 does not need to wait until the branch/return instruction reaches the execute stage 18 before the target address can be determined and authentication started.

The processing circuitry 10 is thus arranged to identify an instruction to authenticate a pointer and perform an authentication process using the address prediction information. In this way, the impact of pointer authentication on the processing circuitry 10 is reduced.

The processing circuitry 10 may be responsive to a particular authentication instruction provided in the instruction set architecture (ISA) supported by the apparatus 2 to perform the authentication process or the need to authenticate may be implied by another instruction/sequence of instructions. For example, the processing circuitry 10 may be responsive to a branch or a return instruction to authenticate a pointer identified by the branch or return instruction. In this case, the branch/return instruction itself is the instruction to authenticate the pointer.

Performing the pointer authentication process on the basis of address prediction information as described may be particularly beneficial where the address prediction storage circuitry 22 is call-return stack storage circuitry and pointer generation and pointer authentication are associated with function call and function return respectively.

Such a scenario is illustrated in FIG. 2. FIG. 2 is an example of program code associated with entering and returning from a function. As shown in FIG. 2, the function begins with a PACIASP instruction. PACIASP is an instruction to generate a pointer signature and identifies the pointer for which a pointer signature is to be generated, a cryptographic key, and context information in the form of the stack pointer to be used to generate the pointer signature. In this example, the PACIASP instruction implicitly identifies the pointer stored in the link register as the pointer for which a signature is to be generated. The pointer signature is combined with the pointer to form an augmented pointer which is stored to the register. In this example, the pointer for which a pointer signature is to be generated identifies the return address to which program flow should be diverted when returning from the function. Typically, this will be the address following the instruction that called the function. This pointer is stored in the link register following entry to the function and is replaced with the augmented pointer following the PACIASP instruction.

As shown in FIG. 2, following the PACIASP instruction is an STP instruction which is an instruction to store the contents of the frame pointer (fp) register and the link register (lr) to a particular memory location. In this example, the memory location to which the contents of the fp register and link register are stored is defined with reference to the stack pointer (sp) stored in the stack pointer 34. Since, the link register contains the augmented pointer (including the pointer signature), it is the augmented pointer that is stored to the memory system 40.

In accordance with the techniques described herein, the address prediction storage circuitry 22 is configured to store address prediction information for the pointer. This may be carried out on function call by pushing the address prediction information comprising the return address to a call-return stack maintained by the address prediction storage circuitry 22. For example, the processing circuitry may be arranged to detect an instruction or sequence of instructions (e.g., a branch with link/function call instruction followed by a pointer signature generation instruction) and in response to this detection, store the address prediction information with the pointer signature to the address prediction storage circuitry.

Following the main body of the function, the function includes a LDP instruction to load back into the fp register and link register the frame pointer and augmented return address pointer previously stored to the memory system 48. This is followed by an AUTIASP instruction. The AUTIASP instruction is an instruction to authenticate the contents of the link register. If the augmented return address pointer that was previously stored to the memory system 40 has not been tampered with, then the processing circuitry 10 is expected to determine that the pointer signature is correct and so the pointer is valid. In this case, the processing circuitry 10 may replace the augmented pointer in the link register with just the pointer indicating the return address. On the other hand, if the pointer has been modified, it is unlikely that the pointer signature will correspond to the pointer and so the processing circuitry 10 will determine pointer is invalid. In this case, the processing circuitry 10 may prevent the pointer from being used and/or raise an exception.

The last instruction making up the function is a return (RET) instruction in response to which the program flow diverts to the location indicated by the return pointer.

In accordance with the techniques described herein, the processing circuitry 10 makes use of address prediction information in the form of call-return prediction information stored in the call-return stack to perform the authentication. Specifically, the processing circuitry 10 may be configured to identify an instruction or sequence of instructions associated with authentication of a return pointer followed by a return operation. In response to detection of this sequence, the processing circuitry 10 begins carrying out the authentication process using the address prediction information predicting the return address. For example, the processing circuitry 10 may be responsive to the combination of an AUTIASP (or similar) instruction followed by a RET instruction earlier in the pipeline than the execute stage 18 to begin obtaining a predicted pointer signature based on the address prediction information which can then be compared with the pointer signature loaded from the memory system 40, before the load and authenticate instructions are actually executed.

FIGS. 3A and 3B schematically illustrate an approach to generating and authenticating a pointer signature respectively. The approaches shown in FIGS. 3A-3B do not make use of address prediction information.

FIG. 3A schematically illustrates an approach to generating a pointer signature 330 for a pointer 310 using a cryptographic key 340. The approach may also make use of context information 350 to link the pointer signature 330 generated to the value of the context information 350 at the time the signature 330 was generated. This can help prevent replay attacks where a pointer signature 330 validly generated for a pointer 310 is used in a manner that was not intended. Since the pointer signature 330 is a valid signature for the pointer 310, unless the signature is dependent on the context information 350, it may be difficult to detect this re-use.

As shown in FIG. 3A, a cryptographic operation is performed using the pointer 310, cryptographic key 340, and context information 350 (if being used) to produce a pointer signature 330. Various cryptographic operations may be used to generate the pointer signature 330, however, in some examples the cryptographic operation is a one-way operation such that the inputs cannot be deduced based only on the signature produced thereby. The cryptographic operation may make use of known cryptography techniques to generate the signature. In some examples a lightweight symmetric block cipher (e.g., a QARMA cipher) or a lightweight cryptographic hash function (e.g., a Keccak hash) is used to provide a high level of security whilst also remaining efficient in terms of processing resources and power required to perform the cryptographic operation. In some examples, the Advanced Encryption Standard (AES) is used for additional security although requiring more computational resources to carry out. In general however, it will be appreciated that any suitable cryptographic algorithm may be used to generate the cryptographic signature.

Once the pointer signature 330 has been generated, the pointer signature 330 is stored in association with the pointer 310. Whilst the pointer 310 and pointer signature 330 could be stored for example in separate registers or at adjacent memory locations, as shown in FIG. 3A, the pointer 310 and pointer signature 330 are combined to form an augmented pointer 320 which can be stored in a register or memory location, for example. As will be explained with reference to FIG. 6, the augmented pointer 320 is formed by replacing a subset of bits of the pointer 310 with the pointer signature 330, providing an efficient way to store both the pointer 310 and the pointer signature 330.

FIG. 3B schematically illustrates an approach by which a pointer 310 can be authenticated. In this example, the pointer 310 to be authenticated and the pointer signature 330 of the pointer 310 are obtained from augmented pointer 320. The same cryptographic operation as was discussed with reference to FIG. 3A is then performed to generate a test signature 360 from the pointer 310, the cryptographic key 340, and context information 352 if being used. The context information 352 (e.g. stack pointer) is context information associated with the execution state of the processing circuitry 10 when the authentication is carried out and so may differ from the context information 350 used to generate the pointer signature 330 if the pointer signature 330 is reused in a context for which it was not intended.

The test signature 360 is compared against the pointer signature 330 to determine whether the signatures match. If the pointer has been tampered with (e.g., an address of the pointer altered) or the context information 352 for the processing circuitry 10 when the authentication is carried out does not match the context information 350 used when generating the pointer signature 330, the test signature 360 and the pointer signature 330 will likely differ. As such, the processing circuitry 10 is configured to determine that the pointer 310 is valid if the two signatures match and invalid if the pointer signatures do not match. In this way, the pointer 310 can be authenticated.

As described above, the pointer signature is authenticated by generating a test signature and comparing the two signatures. Such an approach can typically be performed efficiently and making use of the existing functionality to generate pointer signatures, however, it will be appreciated that other methods of authenticating a pointer signature may be used in accordance with the present disclosure.

The cryptographic operation required to generate the test signature 360 may be costly in terms of the number of clock cycles required for it to be carried out by the processing circuitry 10. However, at least some of this cost can be elided by making use of address prediction techniques that may already be provided within the apparatus 2, as will now be explained with reference to FIGS. 4A-4C.

FIGS. 4A-4C illustrate example approaches to generating and authenticating pointer signatures in a way that reduces the impact on the efficiency of processing circuitry 10 imposed by performing pointer authentication. Some features of FIGS. 4A-4C correspond to the features of FIGS. 3A-3B described. Where this is the case, description of similar features will not be repeated.

FIG. 4A schematically illustrates an approach to generating a pointer signature 330 in which address prediction information is stored to address prediction storage circuitry 22. The approach shown in FIG. 4A is similar to that explained with reference to FIG. 3A, however, in this case, the approach additionally involves storing address prediction information 370 in address prediction storage circuitry 22.

The address prediction information 370 comprises the pointer 310 and in some examples additionally comprises the pointer signature 330 generated as the result of the cryptographic operation and/or the context information 350 used in generating the pointer signature 330. The address prediction information 350 may be information that would be stored by the apparatus 2 anyway for address prediction purposes or the address prediction information 350 may be extended or introduced to support the efficient pointer authentication techniques described herein.

FIGS. 4B-4C illustrate two approaches to authenticating a pointer signature 330 making use of the address prediction information 370 stored in the address prediction storage circuitry 22.

According to the first of these approaches, and as shown in FIG. 4B, the address prediction information 370 stored in the address prediction storage circuitry 22 comprises the predicted pointer 372, the predicted pointer signature 374, and context information 354 corresponding to the execution state of the processing circuitry 10 when the predicted pointer signature 374 was generated. The approach of FIG. 4B therefore corresponds to an implementation of the pointer generation approach shown in FIG. 4A in which the address prediction information 370 stored to the address prediction storage circuitry 22 comprises the pointer 310, the signature 330, and the context information 350, if being used.

The predicted pointer signature 374 is obtained by identifying the signature within the address prediction information 370 and is compared with the pointer signature 330 identified by the instruction to authenticate. In this case, that pointer signature 330 is obtained from the augmented pointer 320. If the pointer signature 330 and predicted pointer signature 374 do not match, then the processing circuitry may determine that the pointer 310 is invalid. However, in this example, a mismatch of the pointer signature 330 and predicted pointer signature 374 instead triggers an auxiliary authentication process. This auxiliary authentication process corresponds to the approach described with reference to FIG. 3B. This auxiliary authentication process is carried out since it is recognised that a mismatch of the signatures may not always correspond to an invalid pointer, but rather other factors could lead to the mismatch. For example, if the pointer was wrongly predicted, the predicted pointer signature 374 may not match the pointer signature 330.

As shown in FIG. 4B, the processing circuitry 10 is configured to also compare the predicted pointer 372 with the pointer 310 identified by the instruction to authenticate. A mismatch of these pointers also triggers the auxiliary authentication process.

Additionally, in examples in which the context information is used, the processing circuitry 10 is configured to compare the context information 354 obtained from the address prediction information 370 with the current context information 352 associated with an execution state of the processing circuitry 10 when the authentication is carried out. A mismatch of the context information may indicate that a pointer is being improperly reused.

If a match is detected in all of the comparisons, the processing circuitry 10 may determine that the pointer 310 is valid and allow the pointer 310 to be used.

According to the approach shown in FIG. 4B, a successful authentication process can be carried out based only on comparisons with information obtained from the address prediction information 370. Indeed, by making use of a signature stored in the address prediction information 370 for the predicted pointer signature 374, the processing circuitry 10 need not carry out the cryptographic operation as part of the authentication. This can reduce the processing load on the processing circuitry 10 and speed up the authentication process. Since the address prediction information 370 may be available earlier than the pointer 310 and the pointer signature 330, the processing circuitry 10 is able to reduce the amount of cycles required to authenticate the pointer following the point at which the pointer 310 is identified and accessible to the processing circuitry 10.

FIG. 4C schematically illustrates a second approach to authenticating a pointer 310 which makes use of a predicted pointer signature 374 obtained from address prediction information 370. According to this approach, the pointer 310 identified by the instruction to authenticate is again compared to the predicted pointer 372.

However, as shown in FIG. 4C, the address prediction information 370 does not include the predicted pointer signature. Instead, the predicted pointer signature 374 is obtained from the address prediction information by generating the predicted pointer signature 374 using the cryptographic operation based on the cryptographic key 340, the predicted pointer 372 from the address prediction information 370 and context information 352, if context information is being used. The context information 352 used to generate the predicted pointer signature 374 may be context information 352 stored in the address prediction information 370 or, as shown in FIG. 4C, may be current context information 352 associated with an execution state of the processing circuitry 10 when the authentication process is carried out.

The predicted pointer signature 374 is compared with the pointer signature 330 identified by the instruction to authenticate, and if context information 354 from the address prediction information 370 is being used the context information is also compared. As explained above with reference to FIG. 4B, if a match is detected in all of the comparisons, the processing circuitry 10 may determine that the pointer 310 is valid. However, if a mismatch is detected in any of the comparisons, an auxiliary authentication process may be performed.

Although, the cryptographic operation is still performed in this approach, the cryptographic operation is performed to generate the predicted pointer signature 374 using the address prediction information 370. Consequently, the cryptographic operation to generate the predicted pointer signature 374 is not dependent on the address of the pointer 310 identified by the instruction to authenticate. This means that cryptographic operation can be started when the address prediction information 370 is available which is typically before the pointer 310 can be identified. As such, the processing circuitry 10 is able to begin generating the predicted pointer signature 374 earlier than an approach requiring the pointer 310 identified by the instruction to authenticate to be available before the cryptographic operation can be performed. This approach therefore reduces the delay introduced when performing pointer authentication.

This approach can also be implemented where the address prediction information 370 comprises only the predicted pointer 372 meaning that the address prediction storage circuitry 22 does not need to be extended to store pointer signatures, thereby increasing the amount of storage available for predicted pointers and reducing the amount of modification required to existing microarchitectures.

FIGS. 5A-5C show timing diagrams illustrating the efficiency improvements that can be achieved with the present techniques. In each of FIGS. 5A-5C is shown the progress of the identified instructions down the pipeline stages of processing circuitry. As illustrated, each instruction requires four clock cycles to complete, although it will be appreciated that in other examples, each instruction could require a different number of clock cycles and in general the number of clock cycles per instruction need not be the same.

FIG. 5A illustrates a timing diagram for instructions being executed on an apparatus that does not make use of address prediction information when carrying out performing authentication. As illustrated, the authentication process (as indicated by the AUTIASP instruction) cannot begin until the load (LDP) has completed. This is because the authentication makes use of the pointer loaded by the load instruction. Load data becomes available once the LDP instruction is at the wr stage of the pipeline and can only be forwarded to the AUTIASP instruction in the iss stage. Thus, the AUTIASP is offset in the timing diagram from the LDP as shown. With the return (RET) performed in parallel with the authentication, it can be seen that the entire load, authenticate, and return operation depicted in FIG. 5A takes seven timing segments to complete. If each illustrated pipeline stage takes one clock cycle to complete, the operation therefore requires seven clock cycles to complete.

Illustrated in FIG. 5B is a timing diagram for the same instructions but in this example, the processing circuitry 10 makes use of address prediction information 370 to begin performing the authentication process before the load has been completed. In this example, the pointer authentication is successful and so the return is allowed to happen without any further processing beyond the authentication process. Consequently, the entire load, authenticate, and return operation can be performed in four timing segments (equivalent to four clock cycles if each illustrated stage of the pipeline requires one clock cycle to complete). By making use of the address prediction information when performing the authentication process, function return can be made more efficient whilst benefitting from the added security provided by pointer authentication.

FIG. 5C shows an example in which the processing circuitry 10 performs the authentication process using the address prediction information, but a mismatch is detected in the comparison (e.g., due to a misprediction of the return address). As such, following the authentication process based on the address prediction information, an auxiliary authentication process is performed in a similar way to the authentication carried out for FIG. 5A. Consequently, where a mismatch was detected and the auxiliary authentication process is carried out, the load, authenticate, and return requires eight timing segments to complete. Although this is longer than the seven timing segments required in the example of FIG. 5A, where the auxiliary authentication process is required on a sufficiently small proportion of function returns, the benefits afforded by making use of the address prediction information may outweigh the additional cost in the cases where a mismatch is detected. This may be particularly the case on function return where the call-return stack can be used to predict with a high level of accuracy, the return address that will be required and so the chance of a misprediction is low.

FIG. 6 illustrates an augmented pointer 600 in which a subset of bits of a pointer are replaced with a pointer signature 604. In some instruction set architectures (ISAs), the number of bits available for storing a memory address in a pointer may be larger than the number of bits of the memory address used to indicate a memory address. For example, the ISA may support 64-bit pointers to address memory, with only 48 of those bits actually used to identify a memory location and the top bits ignored. In such examples, the processing circuitry 10 may make use of the top bits of the pointer to store additional information, thereby creating an augmented pointer. Since storage structures, such as the caches 42, 44, 46 and main memory 48, may already be arranged to store the 64-bit pointers, this approach may allow the additional information to be stored without reducing the space available for storing pointers.

As shown in FIG. 6, the augmented pointer 600 comprises the address bits 606 in which the bits of the memory address that are actually used to identify a memory location are stored. Although the value of the remaining bits in a pointer may typically all be zero, for the augmented pointer, at least some of these bits are used to store the pointer signature 604. Where not all of the unused bits are required to store the pointer signature 604, the augmented pointer 600 may also be used to store further information 602 such as a tag for use in memory tagging.

As shown in FIG. 6, the upper bits of the pointer are replaced with the pointer signature 604 to form the augmented pointer 600. However, in some examples, the pointer and pointer signature may be combined in other ways before being stored. For example, the pointer signature and the pointer may be combined with an arithmetic operation (e.g., by XORing the pointer with the pointer signature).

FIG. 7 illustrates example address prediction information 700 for a pointer. As shown in FIG. 7, for each pointer, the address prediction storage circuitry 22 stores the address 704 of the pointer and the pointer signature 702. The address 704 and pointer signature 702 may together represent an augmented pointer as described with reference to FIG. 6. The address prediction information 700 also comprises context information 706 indicative of an execution state of the processing circuitry 10 when the pointer signature 702 was generated. In this example, the context information 706 is the value of the stack pointer at the point the pointer signature 702 was generated. The address prediction information 708 also contains a valid flag 708 to indicate whether the particular entry 700 is valid.

FIG. 7 schematically illustrates an example of the information stored in address prediction storage circuitry 22, however, it will be appreciated that in other examples more, less, or different information could be stored. For example, in some examples the pointer signature 702, the context information 706 and/or the valid flag 708 is not stored.

FIG. 8 is a flow diagram illustrating a method of generating a pointer signature in accordance with the techniques described herein.

In step 802, the processing circuitry 10 detects an instruction to generate a pointer signature. The instruction may be a dedicated pointer signature generation instruction or may implicitly indicate that a pointer signature is to be generated. The instruction to generate a pointer identifies the pointer for which the signature is to be generated and may also indicate a cryptographic key to used and/or other parameters used to control the pointer signature generation.

In response to the instruction to generate a pointer signature, the processing circuitry 10 is configured to generate the pointer signature based on an address of the pointer and the cryptographic key at step 804.

At least the pointer is then stored in step 806 to address prediction storage circuitry 22 in the form of address prediction information. The address prediction information may also comprise the pointer signature and/or context information used when generating the pointer signature.

FIG. 9 is a flow diagram illustrating a method of authenticating a given pointer in accordance with the techniques described herein.

At step 902, the processing circuitry 10 detects an instruction to authenticate a given pointer. The instruction may be a dedicated authentication instruction or the need to authenticate may be implicitly indicated by another instruction such as a function return instruction. The instruction to authenticate the given instruction identifies the given instruction and the pointer signature associated with the given instruction.

At step 904, a predicted pointer signature 904 is obtained based on address prediction information for the given pointer. In some examples, the obtaining comprises identifying a pointer signature stored in the address prediction information for the given pointer, however, in some examples, the predicted pointer signature is generated using a cryptographic operation performed on the pointer in the address prediction information.

The predicted pointer signature is compared with the pointer signature identified by the instruction to authenticate at step 906. As shown in step 908, if a match is detected, the processing circuitry 10 determines that the given pointer is valid at step 912. However, if the predicted pointer signature and the pointer signature for the given pointer, as identified by the instruction to authenticate do not match, an auxiliary authentication process is carried out in step 914 to determine more conclusively whether the pointer is valid.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may be define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may embody computer-readable representations of one or more netlists. The one or more netlists may be generated by applying one or more logic synthesis processes to an RTL representation. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

1. An apparatus comprising: processing circuitry to execute instructions; address prediction storage circuitry to store address prediction information for use in predicting upcoming instructions to be executed by the processing circuitry; wherein the processing circuitry is responsive to an instruction to generate a pointer signature for a pointer to generate the pointer signature for the pointer based at least in part on an address of the pointer and a cryptographic key; the address prediction storage circuitry is configured to store address prediction information for the pointer, the address prediction information comprising at least the pointer; and the processing circuitry is responsive to an instruction to authenticate a given pointer to: obtain, based on the address prediction information for the given pointer, a predicted pointer signature; compare the predicted pointer signature with a pointer signature identified by the instruction to authenticate; and responsive to the comparing detecting a match, determine that the given pointer is valid.

2. The apparatus according to claim 1, wherein: the address prediction information for the given pointer further comprises the pointer signature; and the processing circuitry is configured to obtain the predicted pointer signature by identifying the pointer signature in the address prediction information for the given pointer.

3. The apparatus according to claim 1, wherein: the processing circuitry is configured to obtain the predicted pointer signature by generating the predicted pointer signature based at least in part on an address of the given pointer from the address prediction information and the cryptographic key.

4. The apparatus according to claim 1, wherein: the processing circuitry is configured to generate the pointer signature based further on context information associated with a current execution state of the processing circuitry.

5. The apparatus according to claim 4, wherein: the processing circuitry is configured to maintain a stack pointer indicative of a location in a memory system corresponding to the end of a program stack referenced by the processing circuitry; and the context information comprises the stack pointer.

6. The apparatus according to claim 4, wherein: the processing circuitry is configured to store the context information as part of the address prediction information; and the processing circuitry is responsive to receiving the instruction to authenticate the given pointer to: obtain the context information from the address prediction information for the given pointer; compare the context information with current context information associated with the current state of the processing circuitry; and perform said determining that the given pointer is valid responsive additionally to detecting a match between the context information and the current context information.

7. The apparatus according to claim 4, wherein: obtaining the predicted pointer signature comprises generating the predicted pointer signature based at least in part on an address of the given pointer from the address prediction information, the cryptographic key and context information associated with a state of the processing circuitry.

8. The apparatus according to claim 7, wherein: the context information used to generate the predicted pointer signature is current context information associated with an execution state of the processing circuitry when the predicted pointer signature is generated.

9. The apparatus according to claim 7, wherein: the processing circuitry is configured to obtain the context information used to generate the predicted pointer signature from the address prediction information.

10. The apparatus according to claim 1, wherein: the processing circuitry is configured to generate the pointer signature in connection with a function call operation; the given pointer is a return pointer to identify a next instruction to be executed following a function return operation; and the processing circuitry is configured to authenticate the return pointer in preparation for the function return operation.

11. The apparatus according to claim 1, wherein: the address prediction storage circuitry is call-return stack storage circuitry to store call-return prediction information for use in predicting a return memory address of an instruction to be executed following a function return operation.

12. The apparatus according to claim 1, wherein: the processing circuitry is configured to generate an augmented pointer based on the given pointer and the pointer signature by replacing a portion of the pointer with the pointer signature and store the augmented pointer in at least one of the address prediction storage circuitry and a memory system.

13. The apparatus according to claim 1 wherein: the processing circuitry is configured to determine, responsive to the comparing detecting a mismatch, that the given pointer is invalid.

14. The apparatus according to claim 1, wherein: responsive to the comparing detecting a mismatch, the processing circuitry is configured to perform an auxiliary authentication process, the auxiliary authentication process comprising: generating, based at least in part on the address of the given pointer and the cryptographic key, a test pointer signature; comparing the test pointer signature with the pointer signature identified by the instruction to authenticate; and responsive to detecting a match between the test pointer signature and the pointer signature identified by the instruction to authenticate, determining that the given pointer is valid.

15. The apparatus according to claim 14, wherein: the processing circuitry is configured to determine, responsive to the comparing in the auxiliary authentication process detecting a mismatch, that the given pointer is invalid.

16. The apparatus according to claim 13, wherein: the processing circuitry is configured, responsive to determining that the given pointer is invalid, to raise an exception.

17. A method of authenticating a pointer, the method comprising: generating, in response to an instruction to generate a pointer signature for a pointer, the pointer signature for the pointer based at least in part on an address of the pointer and a cryptographic key; storing, in address prediction storage circuitry, address prediction information for the pointer, the address prediction information comprising at least the pointer, the address prediction information for use in predicting upcoming instructions be executed by processing circuitry; and in response to receiving an instruction to authenticate a given pointer: obtaining, based on the address prediction information for the given pointer, a predicted pointer signature; comparing the predicted pointer signature with a pointer signature identified by the instruction to authenticate; and responsive to the comparing detecting a match, determining that the given pointer is valid.

18. A computer-readable medium to store computer-readable code for fabrication of an apparatus comprising: processing circuitry to execute instructions; address prediction storage circuitry to store address prediction information for use in predicting upcoming instructions to be executed by the processing circuitry; wherein the processing circuitry is responsive to an instruction to generate a pointer signature for a pointer to generate the pointer signature for the pointer based at least in part on an address of the pointer and a cryptographic key; the address prediction storage circuitry is configured to store address prediction information for the pointer, the address prediction information comprising at least the pointer; and the processing circuitry is responsive to an instruction to authenticate a given pointer to: obtain, based on the address prediction information for the given pointer, a predicted pointer signature; compare the predicted pointer signature with a pointer signature identified by the instruction to authenticate; and responsive to the comparing detecting a match, determine that the given pointer is valid.
